(19) United States
(12) Patent Application Publication
(10) Pub. No.: US 2010/0186301 A1
(43) Pub. Date: Jul. 29, 2010

(54) INTEGRATED METAL COSMETIC STRIP TO OUTERBELT, GLASS RUN, AND UPPER REVEAL

(75) Inventors: Eric Drozd, Farmington Hills, MI (US); James Mistopoulos, Saline, MI (US)

Correspondence Address: FAY SHARPE LLP, 1228 Euclid Avenue, 5th Floor, The Halle Building, Cleveland, OH, 44115, US

(73) Assignee: COOPER-STANDARD AUTOMOTIVE INC., Novi, MI (US)

(21) Appl. No.: 12/600,424

(22) PCT Filed: Jun. 13, 2008
(86) PCT No.: PCT/US08/66887

§ 371 Date: Nov. 16, 2009

Related U.S. Application Data
(60) Provisional application No. 60/934,359, filed on Jun. 13, 2007.

(51) Int. Cl. E06B 7/16

(52) U.S. Cl. 49/490.1; 49/500.1; 49/493.1; 49/475.1; 49/506

(57) ABSTRACT

A weatherstrip (30) for an automotive vehicle includes a rigid core (42) formed from a first material encompassed in an extrusion body (40) of an elastomeric material. A show surface (44), such as anodized metal or stainless steel, is roll-formed and then coextruded in a coextrusion die with the rigid core. A removable layer (94) protects an outer face (90a) the show surface during extrusion and post processing steps of manufacture. The integrated arrangement of the cosmetic strip reduces manufacturing and assembly costs, while providing the desired aesthetic appearance to the weatherstrip.

### BACKGROUND OF THE INVENTION

This application claims priority from U.S. provisional application Ser. No. 60/934,359, filed 13 Jun. 2007, the disclosure of which is expressly incorporated herein by reference.

This disclosure relates to automotive vehicles, and more particularly to weatherstrips used in such vehicles. In addition to functional aspects of the weatherstrip, it is recognized that the aesthetics are also extremely important. Over the years, natural rubber, EPDM, and more recently thermoplastics have been used to form the weatherstrip body—generally referred to as an elastomeric material. It is also common to extrude the body from one of these materials because of the ease and reduced costs associated with this form of manufacture.

One desired show surface provides a cosmetic or bright strip, such as a stainless steel or anodized metal that is joined to the elastomer. Heretofore, such assemblies are a multi-part assembly in which a rigid core is coextruded with the rubber, EPDM, or plastic, and a separately formed metal show surface is then manually assembled to the weatherstrip after the weatherstrip is removed from the extrusion line. Typically, the metal show surface has bent or hooked edges, to define a flattened, generally C-shaped cross-section, in which the hooked edges mechanically grip the previously cured weatherstrip. This show surface or cap is mechanically clinched so that the cap is mechanically engaged with the remainder of the weatherstrip. Likewise, in some instances, the cap is also adhesively bonded to the cured weatherstrip with the application of a separate adhesive.

Another issue with the use of a separate, mechanically joined cap is that a metal core and a separate metal show surface must be formed from a similar material or else a barrier must be provided between the materials. Inclusion of a barrier layer further complicates the assembly and adds to the overall cost. Thus, for example, if a stainless steel show surface is desired, it is necessary to then use stainless steel as the inside core material which makes the weatherstrip cost prohibitive. On the other hand, if dissimilar metals are used, i.e., a less expensive core material, it was still necessary to provide a barrier to protect against corrosion issues. Again, the addition of the barrier layer between the dissimilar metals adds undesired costs.

In addition, the use of caps become relatively expensive for at least two reasons. First, the separate manufacture, inventory, handling, etc. of a clinch-on cap adds to the cost. Secondly, subsequent assembly of the cap to the weatherstrip and the associated labor required to assemble the separate components drive the cost of the assembled weatherstrip to an undesired level.

Another way to form a bright strip in a weatherstrip, is to use a more expensive core material (e.g., stainless steel), stripe coat the core, and then extrude the elastomer around the metal core according to a generally known coextrusion process. Thereafter, the elastomer is removed from those regions of the metal which are not stripe coated (since the elastomer is not bonded to the metal) and thus reveals the underlying show surface. As will be appreciated, however, this requires the use of the expensive metal throughout the entire weatherstrip and significantly increases the cost of the final component.

Thus, a continued need exists for ease of manufacture, reducing the cost to manufacture, reducing assembly steps and cost, and providing a functional weatherstrip while still attaining the desired aesthetics of a metal show surface.

### SUMMARY OF THE INVENTION

An integrated weatherstrip having a show surface that overcomes the above-described deficiencies is provided.

The weatherstrip includes an extrusion body adapted to be secured to an associated vehicle. A core formed from a first material is encompassed in the extrusion body. A metal show surface formed from a second material different from the first material is incorporated into the extrusion body whereby the metal show surface provides an aesthetically pleasing appearance.

In one embodiment, the metal show surface is a stainless steel, and the core is aluminum.

A removable cover layer is provided over the show surface and includes regions of weakness for ease of removal of the cover layer from the show surface after the body has cured.

The weatherstrip may also include an adhesive for bonding the show surface to the extrusion body.

The show surface preferably has hooked edges to preclude removal of the show surface from the weatherstrip.

The core and show surface are segregated from one another along all surfaces by the extrusion body.

The extrusion body may be one of a natural rubber, synthetic rubber, thermoplastic, or another elastomer.

A method of forming the weatherstrip having an aesthetic show surface includes providing a core, providing a metal show surface, introducing the core and show surface into an extrusion die, extruding an elastomer body over the core and metal show surface.

The method may further include tearing away a cover layer of the elastomer body from the show surface after the extruding step.

The method may further include forming hook-shaped edges on the show surface prior to the introducing step.

The extruding step preferably includes introducing elastomer material over the entire surface of the metal show surface.

Preferably, the core and metal show surface are formed to desired configurations different from a planar strip initially introduced into the extrusion line.

An adhesive may also be applied to an interior face of the show surface to enhance bonding between the elastomer body and the show surface.

A primary benefit of this disclosure is the elimination of multiple-piece assembly for the weatherstrip.

Another benefit resides in the decreased amount of expensive metal used in the completed weatherstrip.

Yet another benefit resides in the reduced costs of the weatherstrip.

Still further benefit is the ease of manufacture and the associated reduction in handling and assembly.

Still other features and benefits of the disclosure will become apparent upon reading and understanding the following detailed description.

### BRIEF DESCRIPTION OF THE DRAWINGS

FIG. 1 is a plan view of a portion of a vehicle, particularly the portion associated with a door.

FIG. 2 is an enlarged plan view of a weatherstrip formed in accordance with the present disclosure.

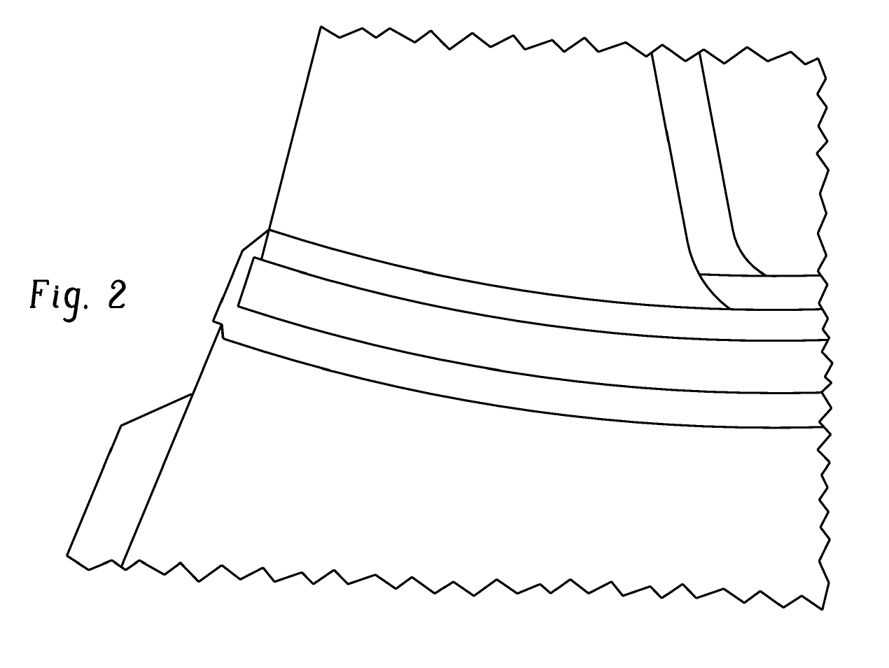

FIG. 3 is a cross-sectional view taken generally along the lines 3-3 of FIG. 1 of an outer belt of the present disclosure.

FIG. 4 is a cross-sectional view taken generally along lines 4-4 of FIG. 1 along the header portion of the glass run.

FIG. 5 is a cross-sectional view of an upper reveal formed in accordance with the present disclosure.

### DETAILED DESCRIPTION OF THE PREFERRED EMBODIMENTS

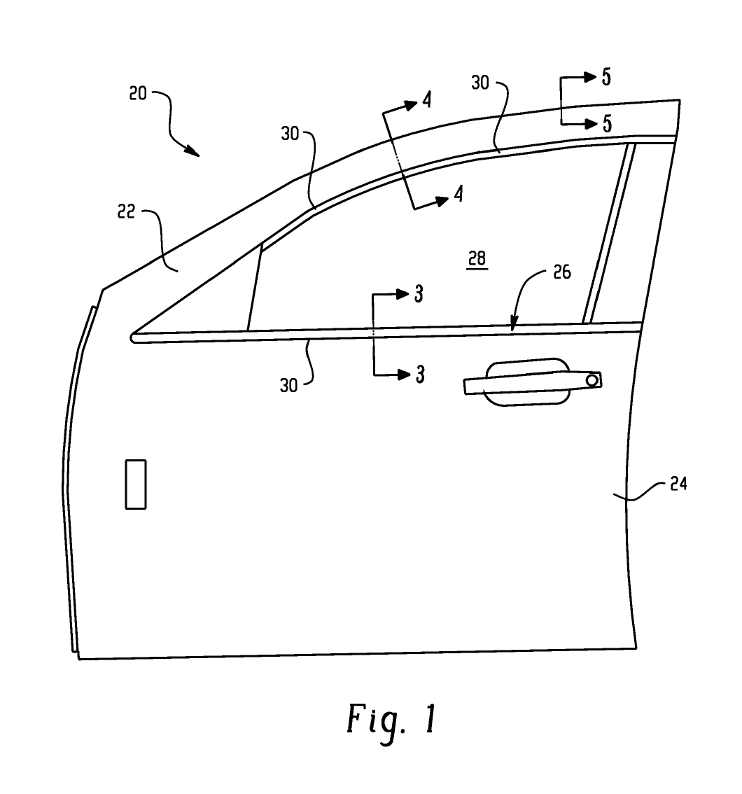

FIG. 1 illustrates an automotive vehicle 20 having a body 22 and a door, such as a front door 24 of the vehicle, which typically includes a window opening 26 that receives a movable window 28 that is selectively raised and lowered. As is well known, one or more weatherstrips 30 are provided on either or both the body 22 and the door 24 to thereby seal around an interface of the body and door, or around a window. In this manner, the interior compartment of the vehicle is not exposed to the external elements. This sealing function also includes sealing around the window opening 26 that receives the window 28.

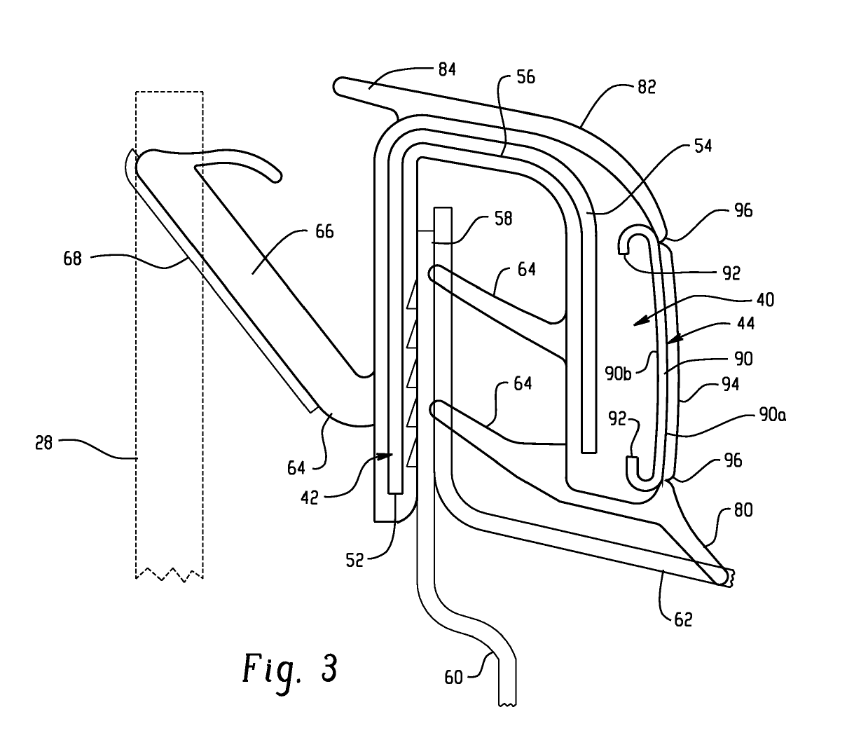

As noted in the Background, it is often desired by the OEM and customer to have a bright strip or show surface along selected regions of the vehicle. A common location for inclusion of these aesthetic accents is in association with the weatherstrip. While prior arrangements have been multi-part, and mechanically assembled arrangements that suffer from the deficiencies noted previously, the present disclosure includes an extrusion body 40 formed around a rigid core such as an aluminum core 42 with a show surface 44 integrated into the coextrusion process and assembly. A portion of the extrusion body provides a physical barrier between the core and the show surface, which are dissimilar metal such as stainless steel, anodized steel, etc. for the show surface and a less costly metal such as aluminum for the core. Because these metals are dissimilar, a corrosion barrier is required. However, the high cost of assembly is reduced with the present weatherstrip, as will become more apparent from a description associated with the weatherstrip cross-sections of FIGS. 3-5.

Turning first to FIG. 3, one preferred form of such a weatherstrip is an outer belt 50 that includes an elastomer body 40 coextruded with the core and show surface. The aluminum core 42 is preferably formed in preliminary process steps (e.g., roll-forming) into an inverted U-shaped configuration including first and second legs 52, 54 extending from an interconnecting portion 56. The legs are dimensioned to provide sufficient rigidity and strength where the completed outer belt is deformed and clinched over a flange 58 formed at the perimeter interconnection of inner and outer door panels 60, 62. In addition, a portion of the elastomer body forms gripping fingers 64 that extend inwardly into the cavity defined by the inverted core and coextruded body to resist inadvertent removal of the outer belt from the flange. Further, another portion of the extrusion body forms a seal lip 66 that preferably has a low-friction material, such as flock 68, on a face thereof and extends angularly outward, for example, from the first leg of the outer belt for sliding, sealing engagement with an external surface of the movable window 28.

A second seal lip 80 is also provided as another portion of the extrusion body and extends outwardly, for example, from the second leg 54 for sealingly engagement with the outer door panel 62 and also to provide a smooth transitional appearance between the outer belt and the door. In addition, a show region 82 of the extrusion body is provided along an upper extremity of the outer belt and preferably includes a hiding lip 84 that extends toward the window. Generally speaking, the description of the structure of outer belt to this point is generally conventional, i.e., the outer belt is preferably a co-extruded structure in which the aluminum core 42 is roll-formed just ahead of, or upstream of, the extruding die into the inverted, generally U-shaped configuration. As the core proceeds through the die cavity, the elastomeric body 40 is extruded therearound to encase the core at least in part, and also advantageously form the gripping fingers 64, first seal lip 66, second seal lip 80, and show region 82. It will also be appreciated that various portions of this body may be formed of different materials due to the intended function or aesthetic purpose that is desired of the particular portion. For example, gripping fingers 64 may be formed of an elastomer such as EPDM having a hardness of approximately 70 durometer, while show region 70 may be formed of the same material. On the other hand, the central body portion encapsulating the core 54 may be formed from an EPDM having a higher, 90 durometer rating. The particular types of elastomer, or hardness of these materials, however, should not be construed to limit the present invention. Rather, the description of these different materials are intended to illustrate that various materials may be used to form the extrusion body of the weatherstrip.

The integrated show surface 44 is shown here as a stainless steel or other desired metal 90 (e.g., anodized steel or bright black steel) having hooked edges 92 that are preferably roll-formed just ahead of, or upstream, of the extrusion die. In this manner, the rigid core 42 and the show surface 44 are both introduced into the extrusion die, and in the preferred arrangement, both are roll-formed adjacent an upstream end of the extrusion die and the elastomer (rubber, EPDM, or thermoplastic, etc.) co-extruded around the core and show surface. It will also be appreciated by one skilled in the art viewing FIG. 3, that a removable cover layer 94 is extruded over an outer face 90a of the stainless steel. In addition, regions of reduced cross-section of the elastomer at edges of the removable cover layer are denoted by reference numeral 96 to define a tear-strip feature that allows the removable layer to separate or tear easily and cleanly from the remainder of the extrusion body and thus reveal the outer face 90a of the metal show surface. Thus, the elastomeric, extruded body 40 completely encompasses both the core formed of a first material (e.g., aluminum) and also completely encompasses a dissimilar, second metal forming the integrated metal show surface 44 (e.g., stainless steel) in a co-extrusion die. Since each of the metals is totally encapsulated during the extrusion process, the elastomeric body serves as an integrated barrier layer without adding further cost to the structure. This permits the use of dissimilar metals in the weatherstrip so that a low-cost, light-weight, rigid core, such as aluminum core 42, can be used in conjunction with a different metal that forms the show surface, such as stainless steel show surface 90.

The edges integrated show surface are also preferably hook-shaped. This provides a lock-shape for the show surface even though it is preferred that the extruded elastomeric material will bond to at least a rear face 90b of the metal show surface. It is envisioned that the elastomeric body will preferably be formed of a compound that has good adhesive qualities for bonding to at least the rear face of the metal show surface, although it will also be appreciated that use of a separate adhesive coating on the metal show surface except for the outer face 90a where the removable layer 94 contacts the metal show surface could be used as an alternative.

The removable layer 94 also serves to prevent inadvertent scratching of the metal show surface during processing through the die. Although the weatherstrip could also be sent to the end customer with the removable layer in place, this likely would not be the normal practice. Instead, the removable layer would be separated post extrusion to allow inspection of the completed weatherstrip. It will be appreciated, though, that the removable layer would likely be maintained in place during any weatherstrip processing such as notching, stretch bending, trimming, or piercing. Once the removable layer is torn off and discarded, a protective film is often reapplied for shipment of the completed weatherstrip to the customer and the protective film removed after installation on the vehicle door or upon delivery of the vehicle to the dealership.

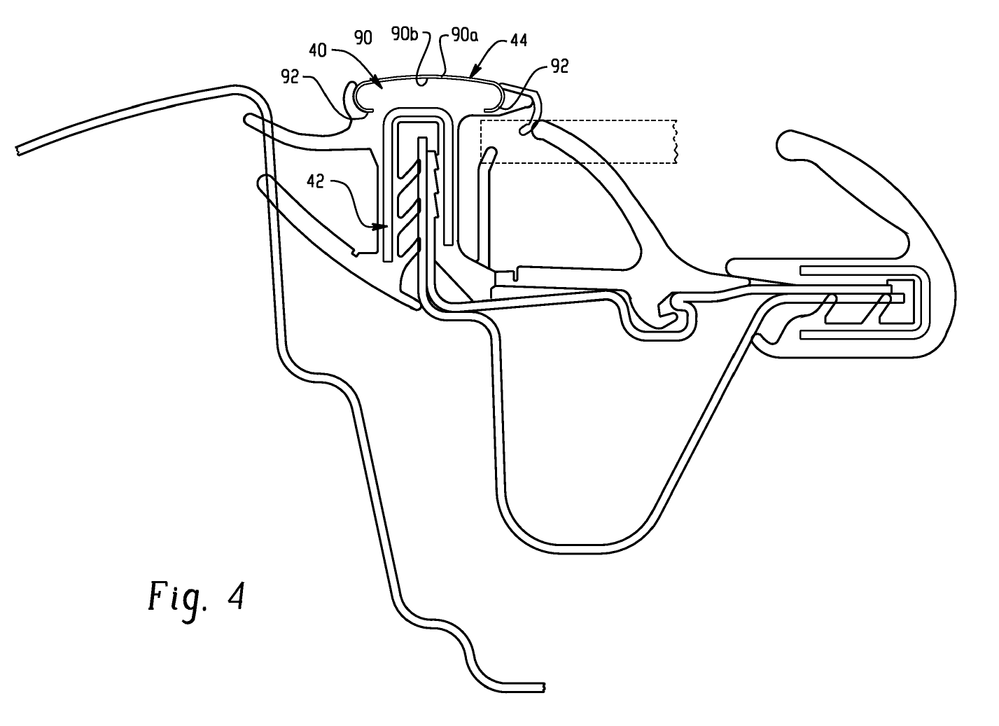

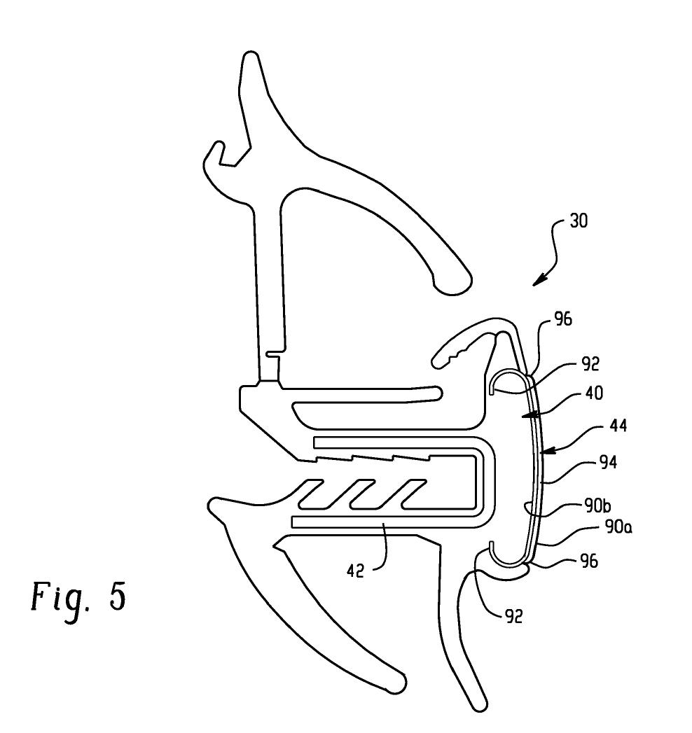

FIGS. 4 and 5, although directed to different cross-sections, employ the same integrated show surface arrangement. Accordingly, where possible the extruded body 40, core 42 and the integrated show surface 44 are identified by like reference numerals. Much of the remaining structure of the weatherstrip therefore applies to alternative functions of the weatherstrip at that particular location on the vehicle.

In summary, this arrangement integrates the cosmetic strip to the outer belt, glass run, or upper reveal weatherstrip. The integrated show surface eliminates multiple piece assembly. It decreases the amount of the show surface, typically stainless steel and reduces the high costs associated therewith. It provides for integrative formation by roll-forming two metal components, of different metal material, to permit them to pass through an extrusion die, where different materials are then coextruded to integrate, encapsulate, and serve as barrier layers therebetween while also providing the desired functions required for the remainder of the weatherstrip. It also provides for a removable layer that protects the show surface during extrusion and further processing.

The invention has been described with reference to the preferred embodiment. Modifications and alterations will occur to others upon reading and understanding this specification. It is intended to include all such modifications and alterations in so far as they come within the scope of the appended claims or the equivalents thereof

1. A weatherstrip comprising:
an extrusion body adapted to be secured to an associated vehicle;
a core formed from a first material encompassed in the extrusion body; and
a metal show surface formed from a second material different than the first material integrated with the extrusion body wherein the show surface provides an aesthetically pleasing appearance.

2. The weatherstrip of claim 1 wherein the metal show surface is stainless steel.

3. The weatherstrip of claim 2 wherein the core is aluminum.

4. The weatherstrip of claim 1 wherein the core is aluminum.

5. The weatherstrip of claim 1 wherein the body includes a connection portion for securing the weatherstrip to an associated vehicle.

6. The weatherstrip of claim 5 wherein the connection portion includes a generally U-shaped region dimensioned for receipt over an associated flange of the associated vehicle.

7. The weatherstrip of claim 5 wherein the core is included at least in part in the connection portion.

8. The weatherstrip of claim 6 wherein the core is also generally U-shaped for receipt over an associated flange of the associated vehicle.

9. The weatherstrip of claim 5 wherein the connection portion includes gripping fingers extending therefrom for engagement with an associated flange of an associated vehicle.

10. The weatherstrip of claim 1 further comprising a removable cover layer over the show surface.

11. The weatherstrip of claim 10 wherein the cover layer includes regions of weakness for ease of removal of the cover layer from the show surface.

12. The weatherstrip of claim 1 wherein the show surface is generally C-shaped with reverse leg portions extending from the show surface in a first direction and embedded in the extrusion body.

13. The weatherstrip of claim 10 wherein the show surface is bonded to the extrusion body.

14. The weatherstrip of claim 13 further comprising an adhesive for bonding the show surface to the extrusion body.

15. The weatherstrip of claim 10 wherein the show surface has hooked edges and the extrusion body extends over the hooked edges of the show surface to preclude removal of the show surface.

16. The weatherstrip of claim 1 wherein the weatherstrip is one of a glass run, outer belt, or upper reveal.

17. A weatherstrip for an associated automotive vehicle comprising:
a body formed from one of plastic or rubber and having an extrudable cross-section;
a core encased in the body for adding strength at selected portions of the body; and
a show surface encased in the body and having an external surface temporarily covered with a removable cover layer.

18. The weatherstrip of claim 17 wherein the removable cover layer includes regions of weakness that facilitate removal of the cover layer from the show surface.

19. The weatherstrip of claim 17 wherein the show surface is formed from a first material different than the core.

20. The weatherstrip of claim 17 wherein the show surface is bonded to the body.

21. The weatherstrip of claim 20 wherein the show surface is bonded along an inner surface to the body.

22. The weatherstrip of claim 20 wherein the show surface is bonded to the body with an adhesive.

23. The weatherstrip of claim 17 wherein the show layer is a first metal and the core is a second metal dissimilar to the first metal.

24. The weatherstrip of claim 17 wherein the show layer is stainless steel and the core is aluminum.

25. The weatherstrip of claim 17 wherein the show surface includes hooked edges that are encased in the body.

26. The weatherstrip of claim 25 wherein an inner layer of the show surface is bonded to the body.

27. The weatherstrip of claim 26 further comprising an adhesive for bonding the show surface to the body.

28. The weatherstrip of claim 17 wherein the core and show surface are separated from one another along all surfaces by the body.

29. The weatherstrip of claim 17 wherein the body is an elastomer.

30. The weatherstrip of claim 29 wherein the elastomer is a rubber.

31. The weatherstrip of claim 29 wherein the elastomer is a thermoplastic.

32. A method of forming a weatherstrip having a show surface comprising:
providing a core;
providing a metal show surface;
introducing the core and show surface into an extrusion die; and
extruding an elastomer body over the core and for securing the metal show surface to the body.

33. The method of claim 32 further comprising tearing away a cover layer of the elastomer body from the show surface after the extruding step.

34. The method of claim 32 further comprising forming hook-shaped edges on the show surface prior to the introducing step.

35. The method of claim 32 wherein the extruding step includes introducing elastomer material over the entire surface of the metal show surface.

36. The method of claim 32 wherein the extruding step includes enveloping the core in the elastomer body.

37. The method of claim 32 further comprising applying an adhesive to a first, interior surface of the show surface to enhance bonding between the elastomer body and the show surface.

38. The method of claim 32 further comprising forming the core into a bent configuration prior to the introducing step.

39. The method of claim 32 wherein the core providing step includes using an aluminum core and the show surface providing step includes using a stainless steel.

40. The method of claim 32 wherein the extruding step includes forming regions of thin material over the show surface to facilitate removal of a cover layer from the show surface.
